(19) United States
(12) Patent Application Publication
(10) Pub. No.: US 2015/0021243 A1
(43) Pub. Date: Jan. 22, 2015

(54) Personal Water Purifier

(71) Applicants: Rodney E Herrington, Albuquerque, NM (US); Katie F Rich, Albuquerque, NM (US); Kevin Roderick, Albuquerque, NM (US)

(72) Inventors: Rodney E Herrington, Albuquerque, NM (US); Katie F Rich, Albuquerque, NM (US); Kevin Roderick, Albuquerque, NM (US)

(21) Appl. No.: 14/373,020

(22) PCT Filed: Jan. 30, 2012
(86) PCT No.: PCT/US12/23063

§ 371 Date: Jul. 19, 2014

(51) Int. Cl. C02F 1/467

(52) U.S. Cl. CPC C02F 1/4674; C02F 1/4676; C02F 2201/46165; C02F 2303/04; C02F 2305/02
USPC 210/85; 204/242; 210/192

(57) ABSTRACT

An electrolytic device and method for generating a disinfecting solution that utilizes a brine generator, an electrical circuit with an on-board solar panel and rechargeable storage battery. The electrical circuit preferably conditions the power received from a variety of power sources to charge the storage battery and conditions the power stored in the storage battery to provide the appropriate power to maximize the disinfection efficacy of the disinfecting solution. The on-board solar panel and/or rechargeable battery can be utilized as the power source to recharge or operate other devices such as cell phones, PDAs, flashlights, GPS systems, or other such devices. The device can incorporate a touch screen display and electronics that is an electronic “water finder” application for locating sources of water that can be made potable. The device can incorporate a biocidal agent and foul resistant water filter that can be folded up to provide a compact configuration for storage.

### TECHNICAL FIELD

The present invention relates to the field of personal water purification devices. More particularly, the invention can provide an electrolytic disinfectant generator, a solar powered charging circuit, and a filtration device.

### BACKGROUND ART

Effective water treatment generally comprises two processes, filtration and disinfection. The United States Environmental Protection Agency and the regulatory agencies of many countries require that drinking water meet limits for clarity, typically measured by the cloudiness of the water and measured as Nephelometric Turbidity Units (NTU), and also that the water have an active disinfectant all the way to the drinking water tap. The active disinfectant standard since disinfection began in 1908 is chlorine. Many programs and devices have been employed to treat water at the municipal level, as well as at the individual level. There are currently 1.2 billion people on the planet who do not have access to safe drinking water, and many of these people are at the bottom of the economic pyramid (BOP). Many treatment strategies have been attempted at the BOP, but they all suffer from the inability to be sustainable. They all require a consumable component that requires periodic replenishment by the user. Users at the BOP typically do not have the economic resources to continue the treatment protocol due to the on-going cost and logistics to support the treatment protocol.

There is a need to provide improved and low cost point-of-use (POU) and point-of-entry (POE) water treatment systems that filter the water and disinfect the water, and that are completely sustainable and do not require an on-going cost to operate.

### DESCRIPTION OF INVENTION

According to the World Health Organization, more than 5,000 children in the world die every day from water-borne diseases. More than 1.2 billion people do not have access to safe drinking water. Many grass roots level campaigns have been conducted by agencies such as the World Health Organization, the Pan American Health Organization, the Center for Disease Control and Prevention (CDC), UNICEF, US AID, many non-governmental organizations (NGOs), private non-profit organizations, and private industries to try and solve this problem. Most of the current schemes involve some form of treatment technology that includes a consumable component. These solutions include distribution of bleach such as the Safe Water Program by the CDC, filtration systems by various organizations, distribution of sachets that contain flocculant aids and disinfectants (aka Pur® sachets), devices that utilize ultraviolet (UV) light as a disinfectant (which do not maintain a disinfectant residual), and various other schemes. One thing they all have in common is that they require a consumable component, and a logistics train to support continued use of the product. They typically require some continued recurring cost to the end user—end users who often cannot afford even the basic fundamentals in life. The present invention preferably does not require a significant consumable for continued use and instead uses common salt, which is considered universally available, and has a shelf life of 10 years or greater. Once a device according to the present invention is distributed, continued use of the device does not require a new logistics train or consumables (other than common salt) and would be highly sustainable at the BOP.

The MSR/MIOX Purifier has been commercialized since approximately 2003. This device is patented under U.S. Pat. No. 6,261,464 to Herrington, et al., entitled Portable Water Disinfection System. This device uses non-rechargeable batteries to electrolyzes salt water brine solution to convert the chloride to chlorine in an electrolysis process. While this device has had significant commercial sales, user feedback indicates that this device suffers from several shortcomings in the commercial marketplace, including: 1) battery replacement requirement, 2) chlorine taste, 3) wait time, 4) lack of particulate removal, 5) complexity of instructions, and 6) high price point.

Example embodiments of the present invention can address all of these shortcomings with new innovations, configurations, and operating parameters.

In an example embodiment, the device comprises an electrolytic cell with a circuit for measuring and controlling the amount of oxidant produced in order to ensure the proper disinfectant dose to the water being treated. The device can be configured to treat different volumes based on the water container volume the end user is using. In an example embodiment, the primary electrical power source is a rechargeable battery that utilizes a solar panel as one means of recharging the battery. Additionally or alternatively, the battery can be recharged from an external power source via a USB port, as an example. In an example embodiment, the on-board rechargeable batteries can also be utilized to power other external devices such as a cell phone, GPS system, a flashlight, or other rechargeable devices. In an example embodiment, the on-board solar panel can be utilized to also re-charge other external devices such as cell phones or GPS devices, as an example.

In an example embodiment of the device, a cell phone or personal digital assistant (PDA) or computer can utilize a downloadable application to utilize either a tethered cable between the devices, or a wireless communication link (e.g., Bluetooth) between the devices to select the appropriate settings on the electrolytic device and activate the electrolytic device, as well as transmit pertinent operating parameters to the cell phone, PDA, or computer to display operating parameters of the electrolytic device such as battery life, electrolyte conductivity, or charging state, among others.

In an example embodiment of the present invention, the device incorporates a novel compact brine generator that utilizes a salt compartment that fits side to side with an electrolysis compartment. The salt compartment holds common sodium chloride salt that can be stored in sufficient quantity to treat many liters of water before the compartment has to be refilled with salt. To generate brine, the electrolysis cell is filled with water then sealed, for example by fitting a cap on top of the electrolysis cell. A water dam is located between the electrolysis cell and the salt compartment so that water placed in the electrolysis cell does not readily enter the salt compartment. As the device is rotated, for example about 90 degrees, the water from the electrolysis compartment flows over the dam to the salt compartment. The user can then shake the device to make salt water brine in the salt compartment. The device is then rotated, e.g. about 90 degrees in the opposite direction, to allow the salt water brine to flow over the dam and in to the electrolysis chamber. The circuit is then activated to convert the brine solution to the appropriate amount of chlorine based oxidant solution via electricity flowing through the controlling circuitry.

Many software applications have been developed for personal digital assistants (PDAs), or cell phones. Applications include GPS-based driving directions, music selections, measuring devices, and thousands of other applications. Applications such as the “Lake Finder” app have been developed by the Department of Natural Resources in Minnesota to help people find recreational lakes. The “Water Water Everywhere” app has been developed in England to help people find tap water sources in London in order to avoid the consumption of bottle water. In an example embodiment of the present invention, a water treatment device can incorporate display, such as a touch screen display, for using a “Water Finder” software application such as those mentioned above. To support the “Water Finder” application, the treatment device can also incorporate a global positioning system (GPS) sensor to identify the location of the user, as well as the location of all water sources on the planet. The application can show the user information such as the location of water sources in the vicinity of the user, the distance to each water source, the type of water at that source, the probability of water at that location based on meterological data, the quality of the water based on historical or seasonal data, and other data that would assist the user to find and treat the water to drinking water standards with the treatment device. A database in the “water finder” application can be developed and updated by users of the system to indicate previous successful treatment scenarios for each of the water sources.

In an example embodiment of the device, the personal purifier can also comprise a compact or folding filtration mechanism that is integral to the device, or additionally or alternately can be removed from the device when being used. Origami (the art of folding paper into complex shapes) techniques can be utilized to develop a folding filter that is in the shape of a cone or cup, but can be folded flat for storage in the device. There are a variety of filter materials that can be suitable, as an example a filter material that adsorbs all of the microorganisms in the raw water, and also destroys all of the microorganism on contact with the filter media, can be suitable. The disinfection characteristics of the filter can also ensure that biofilm does not accumulate on the filter media during storage.

Note that the following discussion refers to a number of publications and references. Discussion of such publications herein is given for more complete background of the scientific principles and is not to be construed as an admission that such publications are prior art for patentability determination purposes.

Electrolytic technology utilizing dimensionally stable anodes (DSA) has been used for years for the production of chlorine and other mixed-oxidant solutions. Dimensionally stable anodes are described in U.S. Pat. No. 3,234,110 to Beer, entitled “Electrode and Method of Making Same,” whereby a noble metal coating is applied over a titanium substrate.

An example of an electrolytic cell with membranes is described in U.S. Patent RE 32,077 to deNora, et al., entitled “Electrode Cell with Membrane and Method for Making Same,” whereby a circular dimensionally stable anode is utilized with a membrane wrapped around the anode, and a cathode concentrically located around the anode/membrane assembly.

An electrolytic cell with dimensionally stable anodes without membranes is described in U.S. Pat. No. 4,761,208 to Gram, et al., entitled “Electrolytic Method and Cell for Sterilizing Water.”

Various commercial electrolytic cells that have been used routinely for oxidant production can utilize a flow-through configuration, pressurized or not, that is adequate to create flow through the electrolytic device. Examples of cells of this configuration are described in U.S. Pat. No. 6,309,523 to Prasnikar, et al., entitled “Electrode and Electrolytic Cell Containing Same,” and U.S. Pat. No. 5,385,711 to Baker, et al., entitled “Electrolytic Cell for Generating Sterilization Solutions Having Increased Ozone Content,” and many other membrane-type cells.

In other configurations, the oxidant is produced in an open-type cell or drawn into the cell with a syringe or pump-type device, such as described in U.S. Pat. No. 6,524,475 to Herrington, et al., entitled “Portable Water Disinfection System.” This device utilizes batteries and an internal circuit to measure electrical current being delivered to the electrolytic cell. Various electronic components and software in the electrical circuit alarm for low salt and low battery condition, and ensure that adequate power is provided to the electrolytic cell to ensure that the oxidant generated by the device has maximum disinfection efficacy.

U.S. Pat. No. 6,736,966 to Herrington, et al., entitled “Portable Water Disinfection System”, which is incorporated herein by reference, describes disinfection devices that utilize, in one instance, a cell chamber whereby hydrogen gas is generated during electrolysis of an electrolyte, and provides the driving force to expel oxidant from the cell chamber through restrictive check valve type devices. In this configuration, unconverted electrolyte is also expelled from the body of the cell as hydrogen gas is generated. In an alternate configuration in the same application, hydrogen gas pressure is contained in a cell chamber during electrolysis, but the pressure within the cell chamber is limited by the action of a spring loaded piston that continues to increase the volume of the cell chamber as gas volume increases. Ultimately, a valve mechanism opens, and the spring-loaded piston fills the complete volume of the cell chamber forcing the oxidant out of the cell chamber.

In electrolytic cells utilizing titanium substrates with noble metal coatings as the anode, the pH at the surface of the anode is typically low, on the order of approximately 3. With sufficiently high brine concentration in the electrolyte, and sufficiently low voltage potential at the anode surface, oxygen generated at the anode surface reacts to form hypochlorous acid and other chlor-oxygen compounds with no oxygen gas liberated. Typical cathodes in these electrolytic cells can be composed of titanium, noble metal coated titanium, catalyst coated titanium, nickel based allows such as Hastalloy, stainless steel, and other conductive materials impervious to high pH conditions. As the cathode, hydrogen is liberated at the cathode surface with a localized high pH value at the cathode surface. During electrolysis, the metal comprising the cathode is not oxidized or otherwise damaged during electrolysis despite the production of hydrogen at the cathode surface. Over time, titanium hydride can form at the surface of a bare titanium cathode which can cause stress concentrations in the cathode surface. To preclude this hydride formation, noble metal or catalyst coatings can be applied to the cathode surface to prevent titanium hydride from forming on the cathode surface when the cathode substrate comprises titanium.

Alternately, anode and cathode electrodes can comprise boron doped nanocrystalline or ultra nanocrystalline diamond electrodes. U.S. Pat. No. 7,144,753 to Swain, et al, entitled Boron Doped Nanocrystalline Diamond describes electrodes for electrolysis. In an alternative embodiment, electrodes can be constructed of boron doped ultra nanocrystalline diamond. One advantage of diamond electrodes is the capability to carry much higher current densities than conventional dimensionally stable anodes (DSA) which facilitates smaller and lower cost anodes for the same chlorine production capacity as DSA anodes. Diamond electrodes are also able to sustain reverse polarity which is useful in decontaminating the electrodes.

An electrolytic disinfection device can utilize sodium chloride as a salt that is converted to brine and is electrolyzed to form sodium hypochlorite or chlorine based mixed oxidants as the disinfectant. Alternately, the device can use some other form of halogen to produce a disinfectant such as sodium hypochlorite, chlorine dioxide, bromine, or other such disinfectant that can be used for disinfection. In an example embodiment, the natural chlorides that are in most waters can be utilized to make chlorine for introduction to the water to be treated. The circuit to power the electrolytic cell can comprise a rechargeable battery and an electric circuit to measure power entering the electrolytic cell chamber and thereby converting chloride and water in the electrolyte to chlorine and oxygen based oxidant components. Said electrical circuit also can integrate over-voltage, under-voltage, over-current, and/or under-current protection circuits to ensure the device is not damaged during charging or discharging of electrical power. Said circuit also can ensure that electrical conditions at the electrolytic cell are adequate to produce oxidant that is effective for the purpose of disinfection.

A rechargeable battery can be recharged using a solar panel. Alternately, the energy storage device can be a super capacitor. The device can also optionally incorporate other devices such as light emitting diodes (LEDs) or light bulbs for light generation (to monitor operation in a dark setting) or signaling, electrical terminals for providing an electrical potential to heat a resistance circuit to generate heat or flame, a global positioning system (GPS) location identification device, an electronic compass, a radio device, an emergency beacon transponder, a cell phone, a digital clock, a camera, a voice or music recorder, a data storage device, or other such electronic components. The device can also be configured to utilize the on-board solar panel or the integral storage devices (battery or supercapacitors, as examples) to charge external devices such as cell phones, PDAs, or other devices that have rechargeable batteries. Control features can also include a tethered or wireless connection to a PDA with a downloadable application that can operate and monitor the features of the disinfection device.

In an example embodiment of the current system, the device is sealed to prevent water intrusion to the inside of the device, and can include waterproofing of any external electrical connections to prevent damage from contact with water. The device can also incorporate a soft exterior band to protect the device from damage due to a drop to a solid surface such as concrete.

In an example embodiment of the present invention, for treating highly contaminated surface water or high turbidity source waters, the system comprises an on-board, or separable, filter to provide pre-filtration of the water to be disinfected. In an example embodiment, the filtration material can comprise a porous sheet to provide physical filtration of suspended particles or microorganisms. Additionally, the filter material can be prepared by incorporating a biocidal material or coating to minimize contamination of the filtration media.

In an example embodiment of the present invention, for treating highly contaminated surface water or high turbidity source waters, the system comprises an on-board (or separable) filter to provide pre-filtration of the water to be disinfected. U.S. Pat. No. 7,901,660 to Xie, et al, entitled Quaternary oxides and catalysts containing quaternary oxides', describes nitrogen doped titanium oxide nano-particles that are effective as disinfectants by producing hydroxyl radicals photochemically when exposed to a light source (including sunlight). By applying these materials to the appropriate substrate filter material, the filter material physically absorbs microorganisms in the filter material and the hydroxyl radicals generated by the doped titanium oxide material proceed to inactivate all of the microorganisms that have been captured by the fabric material. This is achieved without significant pressure loss by simply pouring water through the filter material.

In an example embodiment of the present invention, for treating highly contaminated surface water or high turbidity source waters, the system comprises an on-board, or separable, filter to provide pre-filtration of the water to be disinfected. A paper published Linnea Ista, et al, published in the American Chemical Society journal Applied Materials and Interfaces entitled “Conjugated-Polyelectrolyte-Grafted Cotton Fibers Act as ‘Micro Flypaper’ for the Removal and Destruction of Bacteria”, describes conjugated polyelectrolytes (CPE) that are bonded to a fabric substrate which becomes effective as disinfectant by producing singlet oxygen when exposed to visible light. By applying the CPE to the appropriate substrate filter material, the filter material adsorbs the microorganisms and the light induced singlet oxygen proceeds to inactivate all of the microorganisms that have been captured by the fabric material. This is achieved without significant pressure loss in the filter material.

In order to provide compact storage, yet a useful shape (i.e. cup-shape) for filtering source water, an example embodiment of this invention incorporates origami folding techniques to design an appropriate filter that can be repeatedly folded and unfolded for use or storage in a compact configuration.

Other objects, advantages and novel features, and further scope of applicability of the present invention will be set forth in part in the detailed description to follow, taken in conjunction with the accompanying drawings, and in part will become apparent to those skilled in the art upon examination of the following, or can be learned by practice of the invention. The objects and advantages of the invention can be realized and attained by means of the instrumentalities and combinations particularly pointed out in the appended claims.

### BRIEF DESCRIPTION OF DRAWINGS

The accompanying drawings, which are incorporated into and form a part of the specification, illustrate example embodiments of the present invention and, together with the description, serve to explain the principles of the invention. The drawings are only for the purpose of illustrating a preferred embodiment of the invention and are not to be construed as limiting the invention. In the drawings:

FIG. 1 is four side views of a rechargeable battery powered electrolytic disinfection device.

FIG. 2 is a view of a rechargeable battery powered electrolytic disinfection device with an integral water filter.

FIG. 3 is a view of a rechargeable battery powered electrolytic disinfection device with an integral water filter in the expanded position.

FIG. 4 is a view of a rechargeable battery powered electrolytic disinfection device with a separable water filter in the expanded position.

FIG. 5 is a view of a rechargeable battery powered electrolytic disinfection device with a separable water filter in the expanded position whereby the filter is a rectangular configuration.

FIG. 6 is a view of a rechargeable battery powered electrolytic disinfection device in a simple low cost configuration.

FIG. 7 is a view of a rechargeable battery powered electrolytic disinfection device with an expandable solar panel.

FIG. 8 is a view of an electrolytic disinfection device that incorporates an electronic map with GPS for location of water sources.

FIG. 9 is a view of a brine generator for production of salt water brine.

FIG. 10 is a view of an electrolytic disinfection device with a separate container for storage of salt water brine.

FIG. 11 is a view of an electrolytic disinfection device with an integral container for storage of salt water brine.

### MODES FOR CARRYING OUT THE INVENTION AND INDUSTRIAL APPLICABILITY

The present invention provides a solar power recharged electrolytic device, optionally powered by an energy storage device such as a rechargeable battery or supercapacitor, which can be used to produce disinfectant solution to make water safe to drink. Embodiments of the present invention can further comprise a recharging port, such as a USB port, in addition to the on-board solar panel. Said recharging port can recharge the internal battery in the device from an external power source, and can additionally or alternately be used as a connection port to utilize the internal battery to charge other external devices such as cell phones, GPS receivers, flashlights, or other devices that have rechargeable energy storage capabilities. Common, and low cost, rechargeable batteries typically come in two voltage configurations, 3.7 volts and 1.5 volts DC. USB chargers provide a power source of 5 VDC. A battery must be recharged with a voltage source that is greater than the nominal battery voltage. That is why a typical cell phone charger produces 5 VDC to recharge cell phone batteries, most of which have been standardized at a nominal voltage of 3.7 volts DC. Also, the nominal voltage to produce effective disinfectant needs to be supplied to the electrodes at a voltage of greater than that supplied by a single 3.7 VDC battery. Accordingly, two 3.7 VDC cell phone batteries can be used in series to produce the necessary voltage for the electrolysis process which would then be conditioned by the circuit to send the correct voltage to the electrolytic cell. In an example embodiment of the present invention, four 1.5 VDC rechargeable batteries can be utilized in series to produce 6 VDC which is sufficient voltage to provide power to the electrolysis process, and also sufficient power to recharge batteries in external devices after conditioning by the circuit. In order to recharge the internal batteries in the disinfection device, they can be recharged in a parallel circuit from an external charger providing approximately 5 VDC, or from an on-board solar panel that can be configured to supply approximately 5 VDC. Circuitry on the printed circuit board (PCB) in the device can be utilized to connect the internal batteries in a series configuration during electrolysis or during the time that the internal batteries will be utilized to charge external devices.

Production of disinfectant solutions via electrolysis is well documented in the literature. In the simplest embodiment, the process utilizes an anode electrode and a cathode electrode with a brine solution between the electrodes. Electrical energy is applied to the anode and cathode and transmitted to the brine solution, converting the brine solution to a disinfectant. In a typical electrolysis process, sodium chloride (salt) is added to water in an electrolytic cell chamber. The amount of disinfectant produced is typically a direct function of the amount of energy applied to the brine solution, and is typically independent of the concentration and volume of the brine solution. This feature is fortuitous from an operational standpoint because the operator does not need to closely control how much water is added to the electrolytic cell chamber, nor how much salt is added.

After electrolysis of the salt water solution, the disinfectant produced in the process is added to a container of water to disinfect the water. Unconverted salt in the disinfectant solution is simply added to the water to be treated, thereby increasing the total dissolved solids (TDS) concentration in the treated water. Typically, the amount of unconverted salt added to the treated water is well below the taste threshold. An important aspect of the electrolysis process is control of the voltage and total current applied to the brine solution from the power source, as this effects the quality and strength of the oxidant generated. Fortunately, these characteristics can be controlled by an electrical circuit in the disinfectant device. The electrical circuit can comprise a microcircuit and/or a microcontroller that can be small and low cost.

The electrical circuit is can be capable of conditioning the applied voltage such that the rechargeable battery is properly recharged. The electrical circuit can also cease charging the rechargeable battery when it has become fully charged. Many batteries today are already supplied with this circuitry on-board. Whether the circuitry is supplied with the battery or on the circuit board can be determined as a matter of economics. A full recharge can be indicated by a light emitting diode (LED) or other signaling device. One or more LEDs can also be utilized to provide various indication functions for the device. For example, LEDs can be utilized to indicate salinity that is too low or too high, that the battery voltage is too low to run the cell, or to indicate completion of the electrolysis cycle.

In the operational mode, the electrical circuit can ensure that the proper electrical conditions exist for the electrolysis process. During electrolysis, the voltage applied to the anode and cathode electrodes can be maintained constant throughout the entire process to facilitate production of the proper strength oxidant. Low strength oxidant can result in less than optimum disinfection performance. The electrical circuit can monitor and measure the appropriate voltage and amperage, and can provide an alarm to the user if performance is not within a specified range. Similarly, if low amperage draw is detected due to low brine concentration in the electrolytic cell, the circuit can provide an indication of a low salt condition (e.g., if the user did not add enough salt to the electrolytic cell).

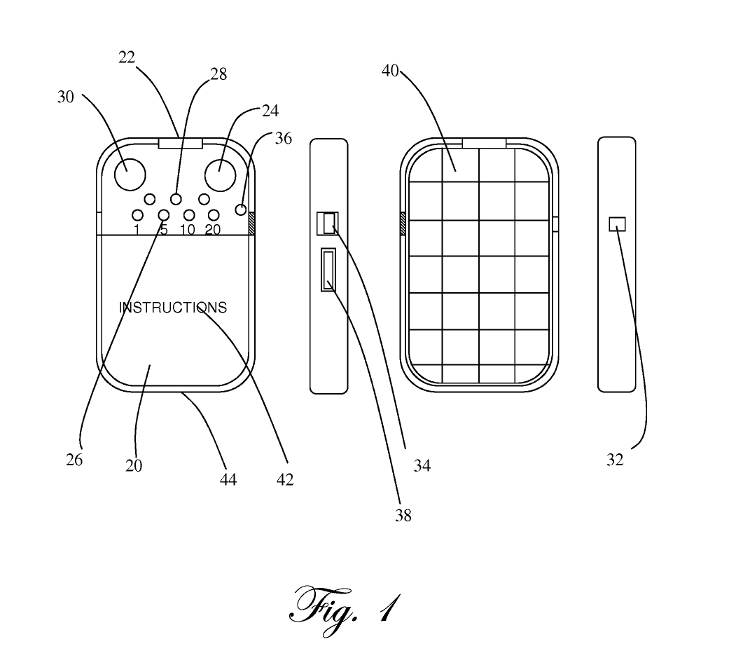

In the example embodiment of the present invention shown in FIG. 1, disinfection device 20 comprises electrolytic cell 22, an electrical circuit comprising a microcontroller, a rechargeable battery, solar panel 40, and electrolysis activation switch 24. Electrolysis activation switch 24 can comprise a membrane switch or other type of hermetically sealed switch to avoid introduction of fluids or other elements to the inside of disinfection device 20. Water is introduced into electrolytic cell 22 preferably followed by the addition of salt. Disinfection device 20 is held, for example vertically, for a suitable time to allow the salt to dissolve in the water thereby forming brine. Electrolysis activation switch 24 is pressed thereby causing electrical current to be discharged from the rechargeable battery or batteries through the electrical circuit to electrolytic cell 22, wherein electrolysis converts the brine to disinfectant. Three electrolysis indicator lights 28 provide indication that 1) the battery voltage is too low, 2) that the salt level is too low in electrolytic cell 22, or 3) that the process is operating properly. To provide maximum flexibility, disinfection device 20 can be equipped with water treatment volume indicator lights 26. Users in the field can have widely varying water collection container sizes. For example, the US military commonly uses 1 liter canteens. On the other hand, the CDC Safe Water Program has distributed numerous 20 liter water containers around the world. As activation switch 24 is pressed, volume indicator lights 26 light up to indicate the volume of water that the user wishes to treat. By repeatedly or continuously pressing activation switch 24, volume indicators lights 26 move from one treatment volume to the next. When the correct treatment volume is lit, the user discontinues pressing activation switch 24, and the electrolysis process begins. The amount of disinfectant produced is controlled by the internal circuit and corresponds with the amount of water to be treated based on the position of volume indicator lights 26.

After the energy in the rechargeable battery is partially or fully depleted, energy can be restored to the rechargeable battery(ies) (or other energy storage device) from solar panel 40 via the electrical circuit. In an example embodiment of the present invention, the battery(ies) can also be recharged from external power sources via USB inlet port 34. The presence of power feeding the onboard battery(ies) is indicated by illumination of charge indicator LED 36. Charge indicator LED 36 can indicate continuous charge whether the onboard battery(ies) are being charged from solar panel 40 or from an external source via USB inlet port 34. In an example embodiment of the present invention, USB outlet port 38 can be utilized to deliver power from onboard solar panel 40 to other external rechargeable devices such as cell phones, GPS devices, flashlights, etc. This can be especially valuable to users in the military on reconnaissance or for disaster relief personnel, or for individuals who might find themselves lost in the outdoors. This feature is not suggested in the prior art related to hand held water purification devices. To further provide utility for disinfection device 20, the complete assembly can be hermetically sealed so that disinfection device 20 can be immersed under water or exposed to other harsh environments without damaging the device. Sealed disinfection device 20 can be buoyant to avoid loss of disinfection device 20 in a body of water. To ensure water tight sealing of disinfection device 20, USB inlet port 34 as well as USB outlet port 38 can also incorporate elastomer covers. In an alternative embodiment of the current invention, light emitting diode (LED) 32 can be activated by LED activation switch 30. This feature allows the operator to operate the device in the dark, or to use disinfection device 20 as a flashlight. For military applications, LED 32 can be omitted, in order to avoid exposing the operator to hostile action, or made in a red light configuration, to preserve night vision of the user.

Also in the example embodiment of FIG. 1, elastomer band 44 surrounds disinfection device 20 in order to protect disinfection device 20 from damage in the event that it is dropped to the floor. This can be especially important to meet military specifications for severe service environments in the field. Since disinfection device 20 is likely to be operated in a wet environment, it is more likely to be dropped in many operational scenarios. In the area below the control panel on disinfection device 20, operating instructions, for example in graphic mode, can be applied to surface 42. Surface 42 can encompass the complete top area of disinfection device 20. In the example embodiment of FIG. 1, surface 42 can comprise an overlay that includes activation switch 24, LED activation switch 30, windows for electrolysis indicator lights 28, volume indicator lights 26, and charge indicator light 36.

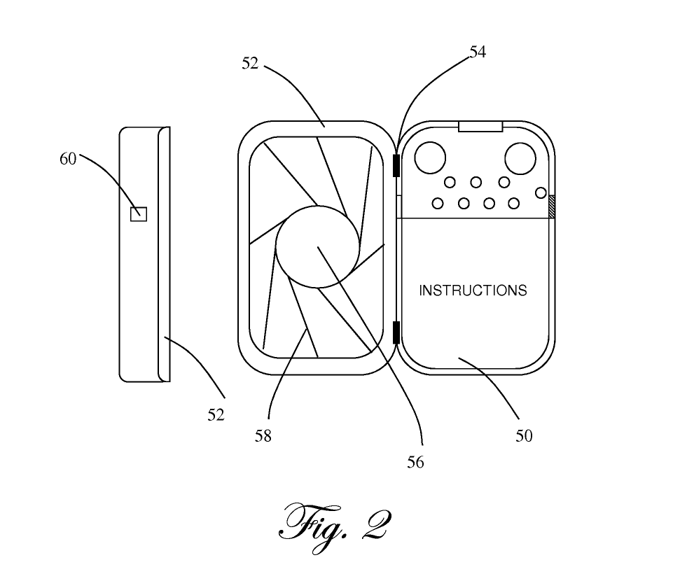

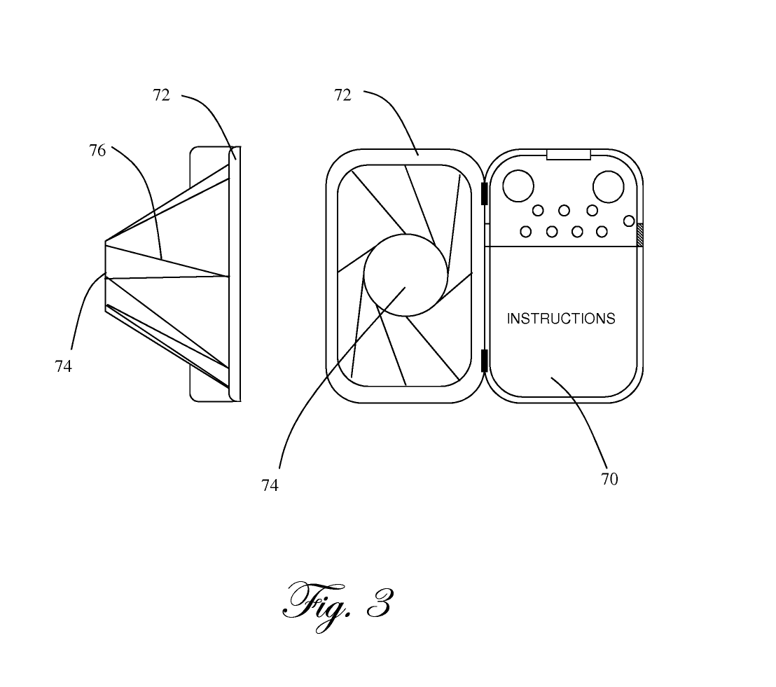

In the example embodiment of the present invention shown in FIG. 2, disinfection device 50 further comprises filter 56 with is retained in cover door 52. This embodiment not suggested in the prior art of hand held electrolytic disinfection devices. Filter 56 can comprise a porous plastic sheet that contains a bacteriacide that prevents filter 56 from becoming contaminated with bacterial residue or biofilms. In the example embodiment of FIG. 2, filter 56 is further comprised of a hydrophobic (water repelling) material to preclude filter 56 from staying wet in storage. Filter seams 58 in filter 56 allow filter 56 to be expanded and collapsed for use and storage. Cover door 52 can be retained in place on disinfection device 50 via hinges 54. In the example embodiment of the present invention shown in FIG. 3, disinfection device 70 comprises filter 74, which is shown in the expanded position in the left view. Filter 74 is housed in cover door 72. By using an origami design, whereby a flat sheet can be folded such that it can be collapsed and expanded, filter 74 can be opened and closed repeatedly. Seams 76 in filter 74 facilitate opening and closing of filter 74.

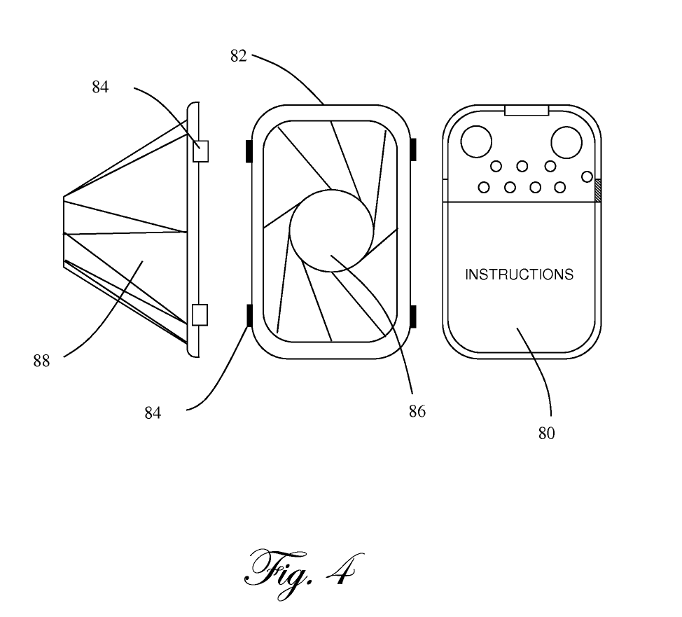

In an example embodiment of the present invention shown in FIG. 4, disinfection device 80 comprises filter 86 which is housed in filter housing frame 82. Filter housing frame 82 is separable from disinfection device 80 but can be retained on disinfection device 80 via attachment clips 84. In FIG. 4, filter 86 is shown in expanded position 88.

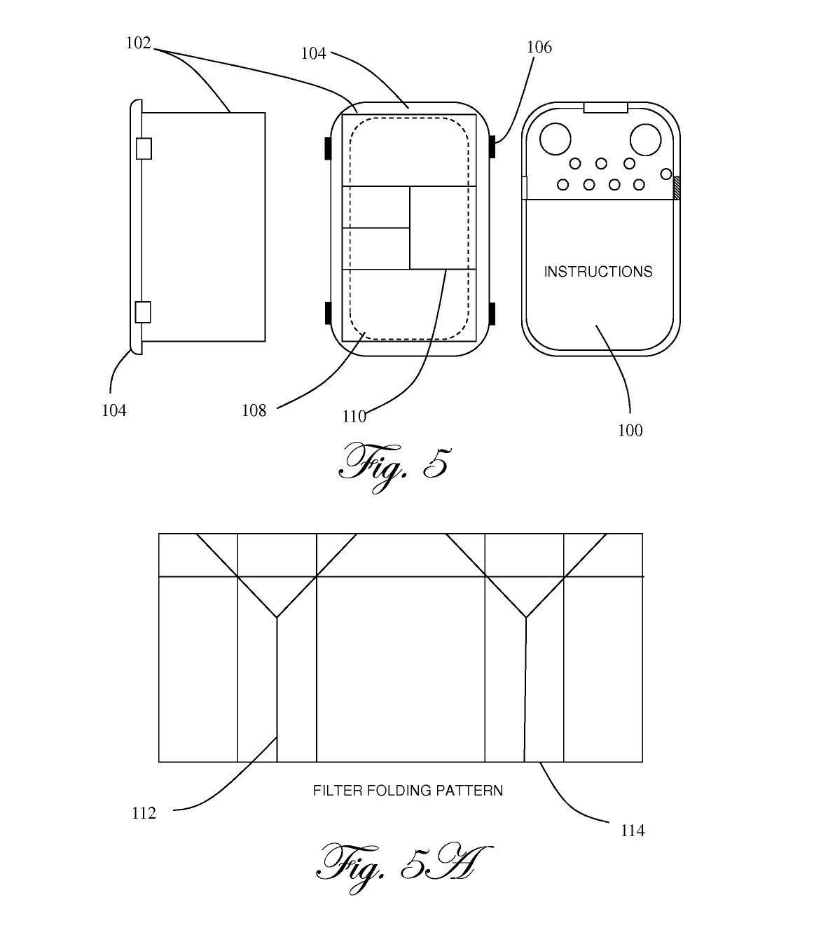

In an example embodiment of the present invention shown in FIG. 5, disinfection device 100 comprises filter 102 attached to cover door 104 which is separable from disinfection device 100. In the storage position, cover door 104 is retained on disinfection device 100 via cover door clips 106. In this example embodiment, cover door 104 comprises cover door opening 108 to facilitate the passage of water through filter 102. Filter creases 110 facilitate folding of filter 102 to the storage position. In FIG. 5, filter 102 is shown in the open, or deployed, position. In the alternative embodiment of the present invention shown in FIG. 5, filter 102 is configured the same way that a paper sack is configured to fold. Folding pattern 114 for filter 102 is shown in FIG. 5A. Seams 112 in folding pattern 114 facilitate flat collapse of filter 102 in order to facilitate storage of cover door 104 on disinfection device 100 via cover door retaining clips 106.

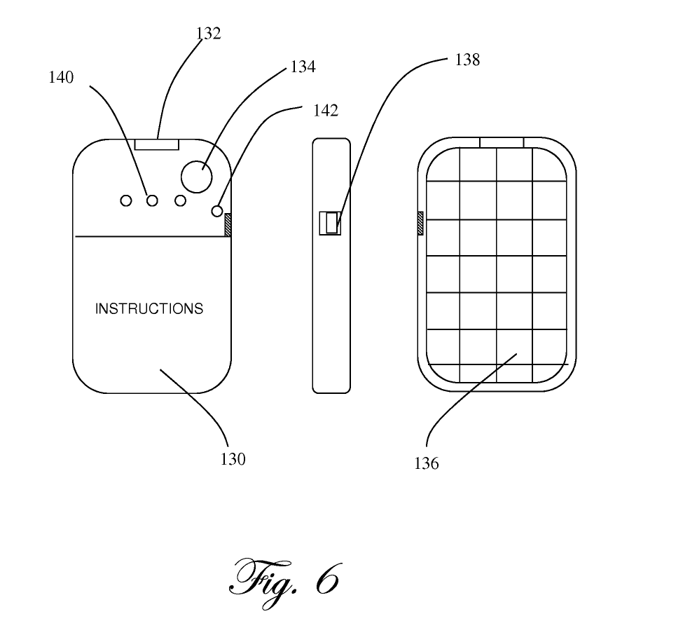

For users at the bottom of the economic pyramid (BOP), local economics and philanthropic organizations demand that the electrolytic disinfection device be as low cost as possible. To be viable at the bottom of the economic pyramid the device must also be sustainable, a feature that no other electrolytic purifier device on the market can claim. In that sense, there must be no consumables such as replacement batteries. In an example embodiment of the current invention shown in FIG. 6, many features are eliminated, relative to other example embodiments, in order to cost reduce the device. Features of other example embodiments that can be eliminated for this example embodiment include LED lights, an elastomer perimeter pad, volume indicator lights, filters, and other options that could have been included. In this configuration, disinfection device 130 comprises an internal rechargeable battery(ies) and electrical circuit for conditioning the power required to electrolyze the brine solution in electrolytic cell 132. Disinfection device 130 also comprises solar panel 136 as well as external charging port 138 for the purpose of recharging the internal rechargeable batteries. Electrolysis condition indicator lights 140 can ensure disinfectant solution is properly made when disinfection device 130 is activated via electrolytic activation switch 134. However, in the configuration of this example embodiment shown in FIG. 6, disinfection device 130 is configured to treat only one volume of water. However, the volume of water can be programmed at the factory into the control circuit to be any volume desired within the limits of the capacity of the system. The programmed volume can be identified on the outside of disinfection device 130 and/or on the instruction set of disinfection device 130. To further facilitate the difference in volumes the device will treat, different volume units can be manufactured in different colors.

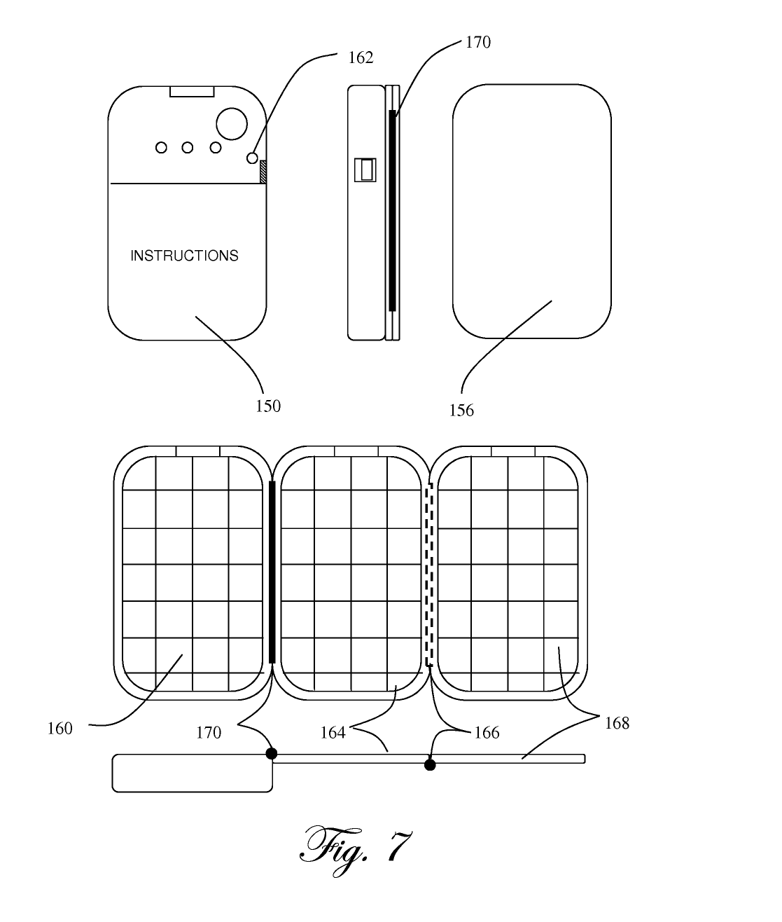

In an example embodiment of the present invention shown in FIG. 7, the device can comprise a folding solar panel so that more solar panel area can be utilized to receive more solar energy that can be applied to charge the internal battery or external devices in a shorter period of time. In this configuration, purifier device 150 comprises multiple solar panels 160, 164, and 168 that can be connected electrically in series or in parallel as desired to obtain the appropriate power for charging the internal battery or external devices. In this embodiment, the number of discrete solar panels can be any number greater than one. The individual solar panels can be attached to each other in any number of ways. In the embodiment of FIG. 7, the solar panels fold alternately such that hinges 170 and 166 are on alternating sides such that the solar panels fold in a “Z” pattern. In alternate configurations, the solar panels can unfold in a continuous pattern. Hinges 170 and 166 can be constructed of plastic, metal, fabric, and any other method that is suitable for the purpose. For protection of the purifier device, the last solar panel, in this case solar panel 168 can have a solid outer cover 156. As solar panels 160, 164, and 168 are generating electrical charge to the battery or device, battery charge indicator light 162 can indicate adequate charge is being applied.

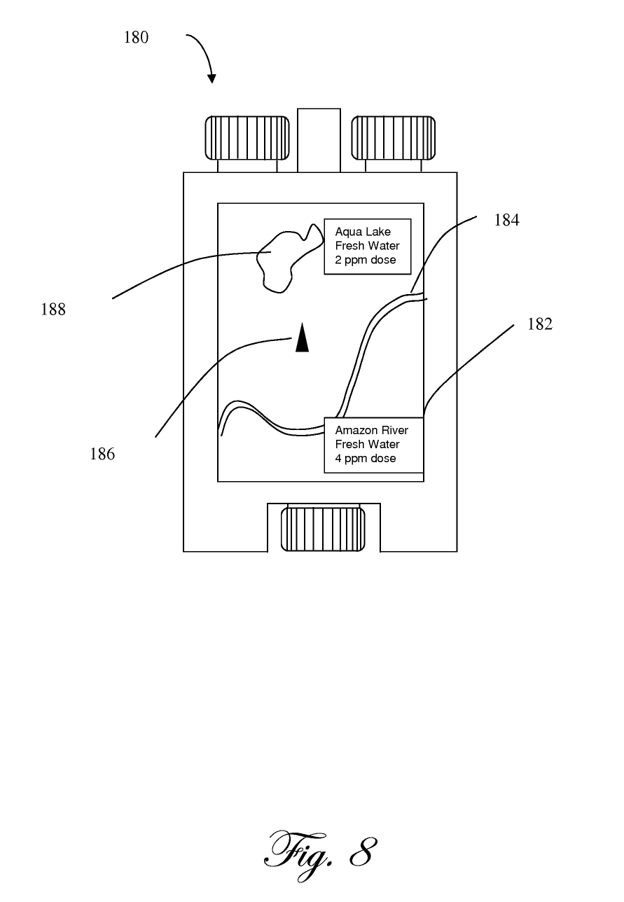

In an example embodiment of the present invention shown in FIG. 8, water treatment device 180 comprises a touch screen electronic display 182. This electronic and software application (“app”) will allow the user to find sources of water in the vicinity of the user, and also allow the user to treat the water to make it potable for human consumption. The “Water Finder” app can utilize a GPS receiver in the device to identify user location 186, and nearby water sources no matter where the user is located on the face of the earth. For example, lake 188 or river 184 can be identified on the screen. The distance to each source of water can be identified along with the quality of water, the probability of water at that location based on meteorological or historical information, and other water quality parameters. An electronic data base can be utilized in the software that allows operators of the system to update the database with information on the water treatment protocol that they used to treat the water. This information will increase with time and will provide new users with up to date information on successful water treatment protocols.

The present invention can also incorporate other devices or electronic components, including but not limited to a compass, a position finding device, a location beacon transmitter, a cell phone, a camera, a clock, a timer, and/or a reflection mirror. The device can also incorporate a Bluetooth circuit to link to a cell phone, personal digital assistant (PDA) or other device that can include a software application (app) to indicate the charge condition of the solar purifier or other data such as the GPS and water location functions described above.

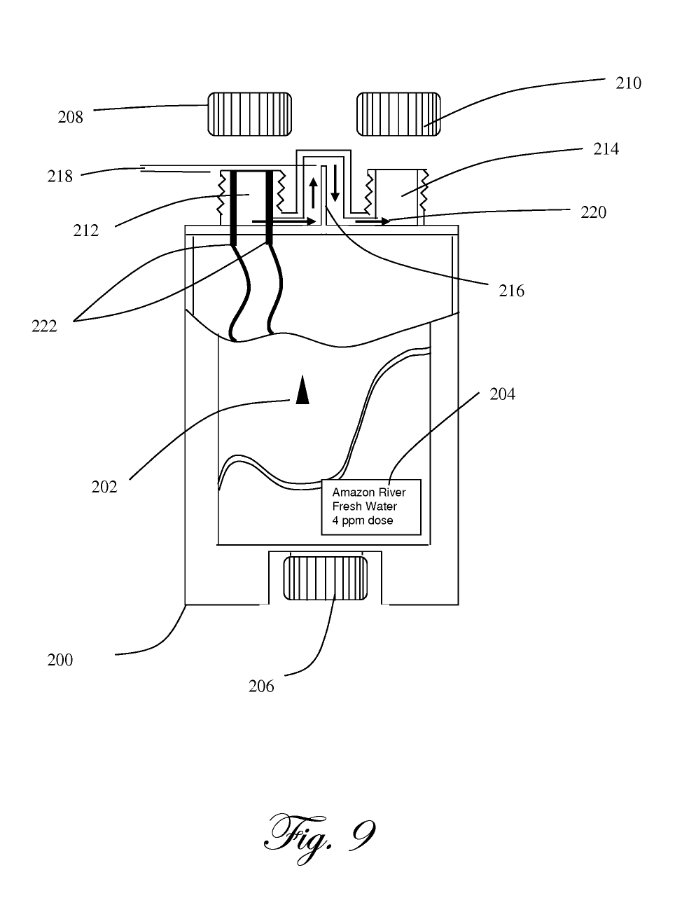

In an example embodiment of the present invention shown in FIG. 9, the water treatment device comprises a two chamber brine generation device. In one embodiment electrolytic purifier 200 comprises a touch screen display that identifies operator location 202 and identifies local water sources 204. Electrolytic purifier 200 further comprises USB cover 206 that acts to hermetically seal USB charging ports for recharging the internal battery. In this embodiment of electrolytic purifier 200, further comprises electrolytic chamber 212 which is normally sealed with electrolytic chamber cap 208. The embodiment further comprises salt compartment 214 which is normally sealed with salt compartment cap 210. In order to generate chlorine based disinfectant solution, the user adds water to electrolytic chamber 212 and then secures electrolytic chamber cap 208 to electrolytic chamber 212. Electrolytic purifier 200 is held in the vertical position during this operation. As water is added to electrolytic chamber 212, water is prevented from passing to salt chamber 214 through passage 220 by virtue of fluid dam 216 which taller in height than electrolytic chamber 212 by distance 218. After electrolytic chamber 212 is filled with water, and electrolytic chamber cap 208 is secured in place, the operator rotates electrolytic purifier 200 90 degrees to the right. Water then flows through passage 220 and in to salt chamber 214. Electrolytic purifier 200 is then rotated back 90 degrees to the vertical position. The user then shakes electrolytic purifier up and down in order to generate salt water brine in salt chamber 214. After brine is manually generated in salt chamber 214, the user then rotates electrolytic purifier 90 degrees counterclockwise so that the salt water brine is transferred through passage 220 back over dam 216 and into electrolytic chamber 212. The user then removes electrolytic chamber cap 208 and activates the operating switch on electrolytic purifier 200 so that the salt water brine (sodium chloride brine) is electrolyzed by virtue of electricity passing through electrodes 222 thereby producing chlorine based oxidants from the sodium chloride brine in electrolysis chamber 212. The chlorine thus produced in electrolytic chamber 212 can now be poured into a raw water container that has been collected from a raw water source. By so doing, the water can be made potable via chemical disinfection from the chlorine based oxidants. Also, in this operational scenario, brine no longer resides in salt chamber 214, and the remaining salt in salt chamber 214 is available for conversion to brine in the next operating cycle of electrolytic purifier 200.

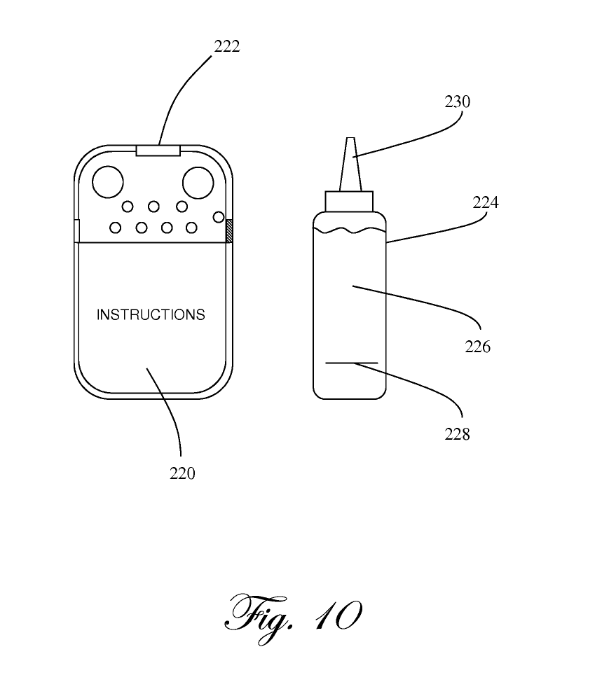

In an example embodiment of the present invention shown in FIG. 10, electrolytic purifier 220 comprises electrolytic chamber 222. Electrolytic purifier 220 further comprises separate brine container 224. Brine container 224 is utilized to prepare brine solution 226 to the proper brine concentration for optimal operation of electrolytic purifier 220. Some advantages of this configuration are that the proper brine concentration assures that salt is not wasted due to excess brine concentration from manual brine preparation, that the brine concentration is not excessive which could result in a salty taste to the water treated, and simplifies the controls circuitry such that the controls circuitry does not have to compensate for variable brine concentrations that can result from manual preparation by the operator. To prepare brine solution 226 properly, the user fills dry salt (sodium chloride or other halogen salt) to salt level 228 in brine container 224. The user then fills the remaining volume of brine container 224 with water. Brine container 224 is then shaken to dissolve all of the salt into the water to ensure proper concentration of brine solution 226. To operate electrolytic purifier 220, the operator fills brine solution 226 from brine container 224 via pour spout 230 into electrolytic chamber 222 until electrolytic chamber 222 is filled completely. The user then operates the switch on electrolytic purifier 220 until chlorine based oxidant solution is produced in electrolytic chamber 222. The control circuit in electrolytic purifier 220 ensures that the correct amount of chlorine solution is prepared. In other embodiments of brine container 224, brine container 224 can be attached to electrolytic purifier 220, or can be integral with electrolytic purifier 220. Pump devices can be incorporated with electrolytic purifier 220 to facilitate transfer of brine solution 226 to electrolytic chamber 222.

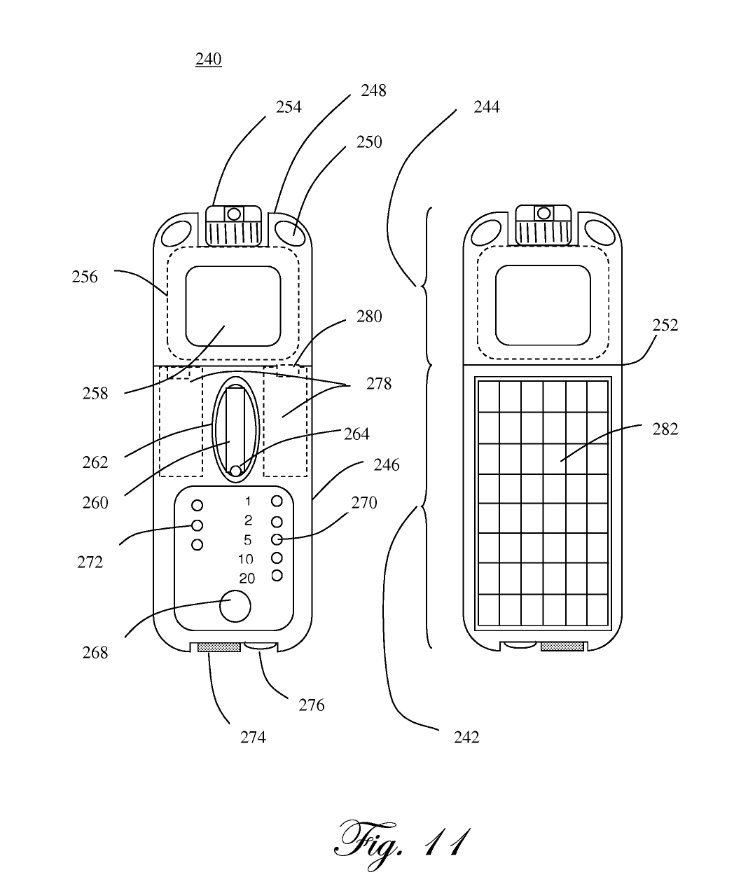

In an example embodiment of the present invention shown in FIG. 11, electrolytic purifier 240 comprises electrolytic unit 242 and integral, but separable brine compartment 244. Brine compartment 244 further comprises brine bottle 256, brine bottle housing 248, brine bottle cap 254, brine bottle housing opening 258, and brine bottle housing lanyard openings 250. In operation, brine compartment 244 is removed from electrolytic unit 242 by any number of means including plastic latches or a horizontal slide rail mechanism with locking detent that separates electrolytic unit 242 from brine compartment 244 at seam or parting line 252. After separation of brine compartment 244, a nozzle on brine bottle cap 254 is opened. The user then points the brine bottle nozzle into cell chamber 260 and dispenses said brine into cell chamber 260. To facilitate squeezing brine bottle 256, brine bottle housing 242 incorporates brine bottle housing windows 258 on both sides of brine bottle housing 248. The initial brine concentration in brine bottle 256 is ensured by loading a prescribed amount of salt and then filling brine bottle 256 with water. By defining the concentration of brine in brine bottle 256, the electrical power circuit does not need to be sophisticated, but can simply be a timer circuit, because the brine concentration in brine bottle 256 is always fixed at a consistent brine concentration. Hence, the brine concentration in brine bottle 256 is functionally calibrated to the electrical circuit. Some advantages of this configuration are that the proper brine concentration assures that salt is not wasted due to excess brine concentration from manual brine preparation, that the brine concentration is not excessive which could result in a salty taste to the water treated, and simplifies the controls circuitry such that the controls circuitry does not have to compensate for variable brine concentrations that can result from manual preparation by the operator. After brine is placed in cell chamber 260 to operate electrolytic unit 242, the operator then activates switch 268 on electrolytic unit 242. As switch 268 is momentarily activated, LEDs 270 light up in sequence as switch 268 is pressed. Each time switch 268 is pressed, a different volume selection is chosen, for example 1, 2, 5, 10, or 20 liters of water to be treated. When switch 268 is held down for a prescribed fixed time continuously (e.g. 1 second), the electrolysis process starts, thereby producing mixed oxidant solution in cell chamber 260. Completion of the electrolysis process can be indicated by any number of means, including activation of cell LED light 264, alarm light 272, or by termination of gas production in electrolytic cell 260. After electrolysis is complete, cell unit 242 is picked up by the operator, and the liquid chlorine solution in cell chamber 260 is poured in to the water to be treated. Pouring the chlorine solution from cell chamber 260 is facilitated by pour lip 262 which is integral to the housing of electrolytic unit 242. Electrolytic unit 242 can also comprise USB charging port 274, an LED acting as a flashlight through clear lens 276, and solar panel 282 on the back side of electrolytic unit 242. The flashlight LED can be activated via switch 268 by utilizing a different activation sequence, say holding down switch 268 for 3 seconds until the LED is activated. By placing device 242 face down, solar energy can recharge an internal rechargeable battery sufficiently to provide at least limited use of the electrolytic unit, for example to provide sufficient treated water for a family of four. When brine is depleted in brine bottle 256, a fresh batch of brine can be generated. Salt storage containers 278 are sized to hold the proper amount of salt to produce the correct concentration of brine in brine bottle 256. Salt storage container lids 280 can be elastomeric in construction, for instance, to seal salt storage containers 278.

As an alternative to utilizing brine bottle 256, the correct concentration of salt can be produced in cell chamber 260 by utilizing a salt applicator. The salt applicator is used to add a predetermined amount of halogen salt to water in the cell chamber 260, thereby creating brine in situ. In one example embodiment, the salt applicator can be comprised of a rod or brush that would first be wetted with water, and then placed in salt storage container 278, allowing salt to stick to the water that is adhered to the applicator. In another embodiment, the salt applicator would comprise a handle and scoop or other measuring device. In yet another embodiment, the salt applicator would comprise a handle and a porous matrix that is pre-impregnated with a halogen salt (e.g. sodium chloride.) The salt applicator would be designed to hold the correct amount of salt that is needed for one charge of brine for cell chamber 260. After cell chamber 260 is filled with water, the salt applicator would be stirred in cell chamber 260 until all of the salt is dissolved.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

We claim:

1. An apparatus to facilitate production of potable water, comprising:
(a) an electrolytic cell configured to generate oxidation/reduction products, at least a first product of which is suitable for disinfecting water;
(b) an electrical system configured to supply electrical power to the electrolytic cell for at least one of (i) a predetermined time, or (ii) until activity in the electrolytic cell indicates that a desired quantity of the first product has been produced;
(c) a housing in which the electrolytic cell and electrical system are mounted.

2. An apparatus as in claim 1, further comprising a filter suitable for filtering water, wherein the filter is mounted with the housing.

3. An apparatus as in claim 2, wherein the filter is mounted with the housing with a removable mounting relationship between the filter and the housing.

4. An apparatus as in claim 2, wherein the filter comprises a sheet prefolded such that it can be configured to a substantially flat configuration and to a configuration that contains a volume of water to be filtered.

5. An apparatus as in claim 2, wherein the filter comprises a hydrophobic material.

6. An apparatus as in claim 2, wherein the filter comprises a biocidal substance.

7. An apparatus as in claim 1, further comprising a display system configured to communicate to a user of the apparatus information concerning the location of water sources near the user.

8. An apparatus as in claim 7, wherein the display system comprises a programmed data processor that identifies water sources to display based on proximity to the current location of the apparatus.

9. An apparatus as in claim 7, wherein the display system further comprises a communication subsystem configured to accept from external sources data concerning water sources.

10. An apparatus as in claim 9, wherein the data concerning water sources comprises data concerning one or more of (a) the location of a water source, (b) the volume of water at a water source, (c) meteorological occurrences in the area of the water source, (d) experience of other users in accessing the water source.

11. An apparatus as in claim 7, wherein the display system further comprises a global positioning system received configured to determine the current location of the apparatus.

12. An apparatus as in claim 1, wherein the housing defines first and second sealable reservoirs and a path allowing fluid to flow between the first and second reservoirs, wherein the fluid path is configured such that fluid can flow through the fluid path when the apparatus is in a first disposition relative to vertical and such that fluid does not flow through the fluid path when the apparatus is in a second disposition relative to vertical, and wherein the first reservoir is a fluid container for the electrolytic cell.

13. An apparatus as in claim 1, wherein the electrolytic cell comprises a first sealable reservoir, and wherein the apparatus further comprises a second sealable reservoir suitable for containing halogen salt such as sodium chloride, wherein the first and second reservoirs are connected by a fluid pathway configured such that fluid in the second reservoir flows to the first reservoir when the apparatus is in a first disposition relative to vertical and does not flow to the first reservoir when the apparatus is in a second disposition relative to vertical.

14. An apparatus as in claim 1, wherein the electrolytic cell comprises a first sealable reservoir, and wherein the apparatus further comprises a halogen salt containment reservoir, and wherein a fluid path connects the first reservoir and the salt containment reservoir, wherein the fluid path is configured such that, when the apparatus is in a first disposition relative to vertical, gravity causes fluid to flow from the first reservoir to the halogen salt containment reservoir; and when the apparatus is in a second disposition relative to vertical, gravity causes fluid to flow from the halogen salt containment reservoir to the first reservoir.

15. An apparatus as in claim 14, wherein the fluid path is further configured such that, when the apparatus is in a third disposition relative to vertical, fluid does not flow between the first reservoir and the halogen salt containment reservoir.

16. An apparatus as in claim 14, wherein the first reservoir defines a fluid chamber characterized by a top and bottom when the apparatus is held such that an axis of the apparatus is vertical, and wherein the fluid path is configured such that, for at least a portion of the fluid path, the lowest surface of the fluid path is above the top of the chamber when the apparatus is held such that the axis is vertical.

17. (canceled)

18. An apparatus as in claim 1, wherein the electrical system further comprises a solar power generation device.

19. (canceled)

20. An apparatus as in claim 17, wherein the electrical system further comprises a connector configured to allow energy from the device to supply energy to a load external to the apparatus.

21. (canceled)

22. (canceled)

23. (canceled)

24. An apparatus as in claim 18, wherein the solar power generation device comprises a plurality of solar panels, mounted in a foldable relationship.

25. (canceled)

26. An apparatus as in claim 1, further comprising a separable brine compartment.

27. (canceled)

28. (canceled)

29. (canceled)
